(19) United States
(12) Patent Application Publication
(10) Pub. No.: US 2008/0160411 A1
(43) Pub. Date: Jul. 3, 2008

(54) Conductive-structured electrode

(75) Inventors: Pin-Chi Chiang, Hsinchu (TW); Tsung-Hsiung Wang, Hsinchu (TW); Chang-Rung Yang, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/984,282

(22) Filed: Nov. 15, 2007

(30) Foreign Application Priority Data
Dec. 28, 2006 (TW) 095149397

(51) Int. Cl. H01M 4/62; H01M 4/50; H01M 4/52

(52) U.S. Cl. 429/221; 429/223; 429/224; 429/231.95; 429/232

(57) ABSTRACT

A conductive-structured electrode is proposed. The proposed conductive-structured electrode includes a tubular 3D electron passage structure made of one or more first-type conductive additives for conducting electrodes; a connecting/continuous conductive 3D structure made of one or more second-type conductive additives for adhering active substances and framing the tubular 3D electron passage structure; and a 3D porous structure formed by the first-type and second-type conductive additives for adhering active substances and framing the tubular 3D electron passage structure. The interior of the stated network-like 3D structure formed by the tubular 3D electron passage structure and the connecting/continuous conductive 3D structure can be used as an ion passage. The network structure itself can increase adhesion of active substances on substrates, and the conductive passage can facilitate rapid conduction of electrons. Thus, the invention is suitable for making batteries, which have increased C-rate performance.

### BACKGROUND OF THE INVENTION

1. Field of Invention

The present invention relates to conductive-structured electrodes, and more particularly, to a conductive-structured electrode containing conductive additives.

2. Description of Related Art

Advantages of secondary lithium-ion batteries include high energy densities, high operating pressures, and stable discharging properties. Many nations are aggressively researching and developing secondary lithium-ion batteries with improved performance and lowered cost to meet market demands. To improve conductivity of lithium oxide electrodes, highly conductive additives are usually added and well-mixed in lithium oxide slurry to increase the overall conductivity of lithium oxide electrodes.

Patents and literatures regarding the use of conductive additives to increase the overall conductivity and the electrical property of electrodes mainly focus on cathodes. Examples of the above-mentioned patents include U.S. Pat. No. 6,806,003, U.S. Publication No. 2004224232, Japanese Patent No. 41-55776, Canadian Patent No. 2341693, and Taiwan Patent No. 232607, wherein the U.S. Pat. No. 6,806,003 and the U.S. Publication No. 2004224232 disclose using carbon fibers and carbon flakes as conductive additives in cathodes and a synergistic effect generated therefrom to improve the ability to retain electrolytes and conductivity of active species, in turn, improving the conductive performance and loading ability of high load current of electrodes. The Taiwan Patent No. 232607 discloses using a small amount of carbon fibers and carbon flakes in nanometers to form a meso-phase graphite mixture in cathodes to increase conductive performance, wherein the carbon fibers and the carbon flakes are formed by thermal chemical vapor deposition

Japanese Patent No. 70-14582 discloses adding carbon materials to anodes to lower battery impedance. Japanese Publication No. 2003-092105 discloses improving an anode discharging at low temperatures. The bottom ends of the carbon materials disclosed in the Japanese Publication No. 2003-092105 are open-ended, which can provide uniform pore shapes and is capable of enhancing performance of electrodes during low temperature testing. Japanese Publication No. 2004-022177 and Japanese Patent No. 70-14582 both disclose carbon materials for increasing conductivity. However, Japanese Publication No. 2004-022177 discloses that all electric conductive carbon materials make up 10% of powder in an anode, and the conductive carbon materials must contain graphite. Japanese Publication No. 2006-127923 discloses conductive carbon materials containing carbon fibers and carbon flakes, which become slurry including conductive carbon materials and adhesives after mixing. Coating of the slurry traverses a magnetic field provided by an external force, such that the direction of all conductive carbon materials is perpendicular to the surface of the substrate, and the distribution of liquid slurry on the substrate is fixed afterwards by baking.

The above-mentioned patents have not disclosed making a conductive-structured electrode by mulling and designing the structure of a combination of graphite flakes, tubular carbon fibers, and lithium oxide, thereby increasing charge and discharge rates.

### SUMMARY OF THE INVENTION

In light of the shortcomings of the above prior arts, an objective of the invention is to provide a conductive-structured electrode, which has high efficiency.

Another object of this invention is to provide a conductive-structured electrode, which can increase battery charge and discharge rates.

In accordance with the foregoing and other objectives, the invention proposes a conductive-structured electrode, which comprises: a tubular 3D electron passage structure made of one or more first-type conductive additives for conducting electrons; a connecting/continuous conductive 3D structure made of one or more second-type conductive additives for adhering active substances and framing the tubular 3D electron passage structure; and a 3D porous structure formed by the first-type and second-type conductive additives for providing a conducting passage for electrolyte or electrolytic ion. The interior of the stated network-like 3D structure formed by the tubular 3D electron passage structure and the connecting/continuous conductive 3D structure can be used as an ion passage. The network structure itself can increase adhesion of active substances on substrates, and the conductive passage can facilitate rapid conduction of electrons. Thus, the invention is suitable for making batteries, which have increased C-rate performance.

### BRIEF DESCRIPTION OF THE DRAWINGS

FIG. 1 is a diagram showing the rheometry of slurries in comparative example 1 and example 1 of the invention;

FIG. 2 is a diagram showing an electrode structure of the comparative example 1 under electron microscopy;

FIG. 3 is a diagram showing an electrode structure of the example 1 under electron microscopy;

FIG. 4A is a top view of an electrode structure of the example 2 under electron microscopy;

FIG. 4B is a bottom view of an electrode structure of the example 2 under electron microscopy;

FIG. 4C is a sectional view of an electrode structure of the example 2 under electron microscopy;

FIG. 5A is a top view of an electrode structure of the example 3 under electron microscopy;

FIG. 5B is a bottom view of an electrode structure of the example 3 under electron microscopy;

FIG. 5C is a sectional view of an electrode structure of the example 3 under electron microscopy;

FIG. 6A is a top view of an electrode structure of the example 4 under electron microscopy;

FIG. 6B is a bottom view of an electrode structure of the example 4 under electron microscopy;

FIG. 6C is a sectional view of an electrode structure of the example 4 under electron microscopy; and

FIG. 7 is a diagram showing discharge capacities for high current of batteries with the comparative example 1 and the example 1 as the anodes thereof.

### DETAILED DESCRIPTION OF THE PREFERRED EMBODIMENTS

The conductive-structured electrode of the invention is mainly used in an anode of lithium ion batteries. Generally, anode of lithium ion batteries mainly comprises anode active substances, such as lithium cobalt oxide (LiCoO₂), lithium manganese oxide (LiMn₂O₄), lithium nickel oxide (LiNiO₂), lithium iron phosphate (LiFePO₄), or a mixture thereof; conductive additives, such as graphite, Vapor Grow Carbon Fiber (VGCF), or carbon black; adhesives, such as polyvinylidene fluoride (PVDF), polyarylsulfone (PAS), polytetrafluoro ethylene (PTEF); and solvents, such as N-methyl pyrrolidone (NMP).

The conductive additives used by the invention can be classified into first-type conductive additives and second-type conductive additives. The first-type conductive additives are defined as the tubular conductive materials, the striated conductive materials, the rod-shaped conductive materials, or the fibrous conductive materials with the respective lengths thereof in Z direction being greater than that in X and in Y directions. On the contrary, the second-type conductive additives are defined as the flaked conductive materials, the layered conductive materials, or the granular conductive materials with the respective lengths thereof in X and in Y directions being greater than that in the Z direction. The invention mainly uses a spatially stable coordination generated from the differences in structure and property of the first-type and the second-type conductive additives to form a multifunctional network-like 3D structure through interactions, such as stacking, laminating, and aggregating within and among heterogeneous structures. Active substances are uniformly retained in the network-like 3D structure to obtain a highly efficient electrode.

The first-type conductive additives used by the invention are carbon conductive materials (such as carbon tubes, carbon fibers, and VGCF) or non-carbon conductive materials (such as metals, conductive composites, and highly conductive molecules). The first-type conductive additives can aggregate into strings and combining into network-like 3D structures, which form a tubular 3D electronic passage structure. The second-type conductive additives used by the present invention are carbon conductive materials (such as carbon black, graphite, or carbon-60) or non-carbon conductive materials (such as metals, conductive composites, and highly conductive molecules). The second-type conductive additives can be stacked into 3D structures to form a connecting/continuous conductive 3D structure. The space unoccupied by the tubular 3D structure and the connecting/continuous conductive 3D structure is the 3D porous structure.

In one embodiment, the slurry is formed by mulling LiCoO₂, PVDF, the flaked conductive materials KS and the tubular conductive materials VGCF in a solvent, where LiCoO₂ and PVDF are used, respectively, as the active substance and the adhesive for the electrode. After mulling, the tubular conductive materials VGCF are distributed over the electrode substrate in strings, which also wrap flaked conductive materials KS. In addition, the tubular conductive materials VGCF and the flaked conductive materials KS are linked tightly each other by the adhesive, i.e. the PVDF, to form a multifunctional network-like 3D structure. Through rheological measurements by a rheometer, degrees of mixing can be determined based on the rheological curve. Vacuum is applied to ensure that there are no residual air bubbles in the slurry, so that the slurry can be uniformly coated over the electrode substrate by use of a coater. Examples of the substrate include aluminum foil substrates, aluminum alloy substrates, nickel foil substrates, platinum foil substrate or copper alloy foil substrates. In the embodiment, the coating speed is in the range of 0.1 to 20 m/min, preferably in the range of 0.1 to 10 m/min, and more preferably in the range of 0.5 to 5 m/min.

The temperature used in a baking step to evaporate solvents is in the range of 60 to 250° C., and preferably in the range of 100 to 180° C. The active substance lithium cobalt oxide is uniformly retained in the multifunctional network-like 3D structure formed by the flaked conductive material KS and the tubular conductive material VGCF. After the slurry is completely dry, using an axis roller to make the structure finer and firmer performs a rolling process, thereby producing a highly efficient anode.

Due to the relationship between structures and densities, the flaked conductive material KS is more easily to float after mulling. The floated flaked conductive material KS is prone to form an electric passage on the surface of the electrode to facilitate surface reactions. The tubular conductive material VGCF deeper into stacked particles is vertically and horizontally stringed in sequence over and linked to different stacks of particles to form vertical and horizontal electron passage networks, which link to surfaces and aluminum alloy substrates, thereby achieving highly efficient electron conduction and high lithium ion conversion rate.

On the contrary, the presence of the tubular conductive material VGCF poses steric hindrance to the flaked conductive material KS, causing the flaked conductive material KS unable to fully float on the upper layer of the substrate in a planar fashion. In turn, the flaked conductive material KS floats in a non-planar fashion or undulates. This leads to an increase in the contact area between the flaked conductive material KS and the active substance lithium cobalt oxide to form free space, which substantially increases the lithium ion conversion rate.

Similarly, the presence of the flaked conductive material KS also poses a steric hindrance on the tubular conductive material VGCF, causing the tubular conductive material VGCF unable to be perpendicularly rooted in the pores among particles, and cannot traverse the surfaces of the particles, either. Instead, the tubular conductive material VGCF is pushed to the slot in the particle exchange interface, forming big tubes of tubular conductive materials. The tubes will form a 3D conductive network having a big electron passage, which facilitates rapid electron transmission on surfaces of electrodes and aluminum alloy substrates.

The invention uses intertwining between the tubular conductive material VGCF and the flaked conductive material KS on an aluminum substrate to form an extensive, network-like 3D structure with adhesives and active substances. This type of network-like 3D structure has small network-like passages, big tubes of passages, as well as gaps among structures that can form flow channels therein. Accordingly, this type of network-like 3D structure can be used in making electrodes, while increasing the transmission speed of electrons and ions. Moreover, the small network-like passages and big tubes of passages in the network-like 3D conductive-structured electrode can also cause small aggregates of lithium cobalt oxides, leading to formation of a porous structure. The porous structure can facilitate passage of ions to increase the release and accumulation of capacitance.

### Comparative Example 1

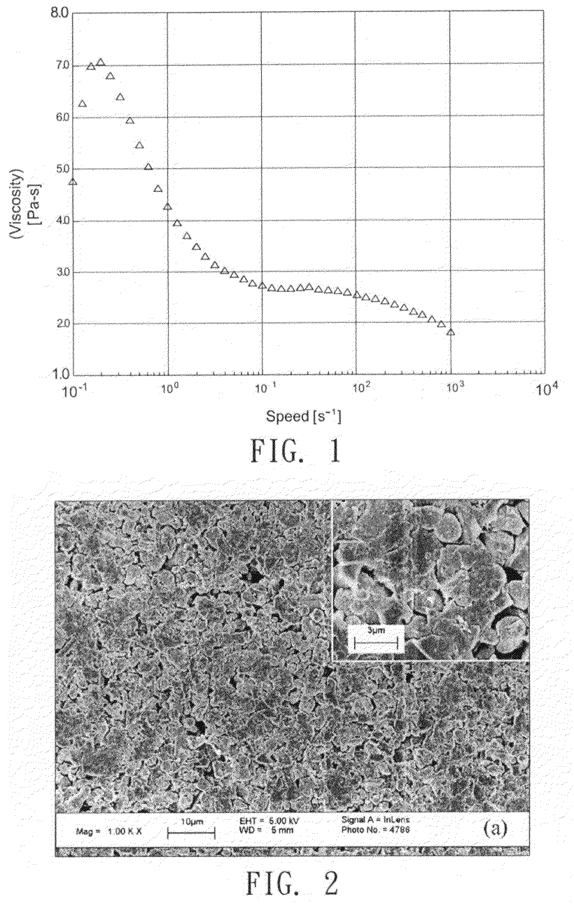

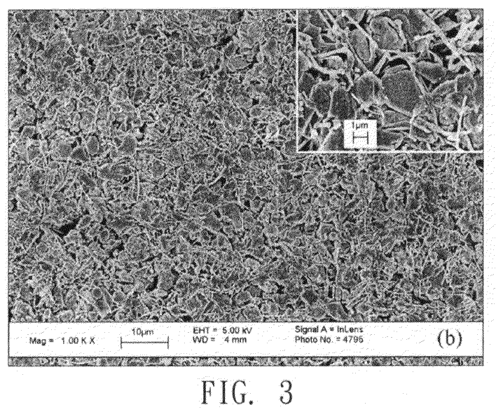

NMP was used as a solvent, and 89 wt % of LiCoO₂, 4 wt % of PVDF, and 7 wt % of flaked conductive material KS were added. The rheological curve of the slurry shown in FIG. 1 was determined by use of a rheometer to measure the viscosity of the slurry. The slurry was coated onto the electrode substrate at a speed of 1 m/min. An oven with a total length of 3 meters was used to perform a two-stage heating process at 110° C. and 130° C. After the solvent was completely evaporated, a rolling process was performed to make the electrode sample in example 1, as shown in FIG. 2.

### Example 1

NMP was used as a solvent, and 89 wt % of LiCoO₂, 4 wt % PVDF, and 7 wt % of conductive additives were added, wherein the 7 wt % of conductive additives is consisted of 4 wt % of flaked conductive material KS and 3 wt % of tubular conductive material VGCF (having a diameter of 100 to 200 millimeters; a length of 10 to 20 micrometers). The rheological curve of the slurry shown in FIG. 1 was determined by use of a rheometer to measure the viscosity. The slurry was coated onto the electrode substrate at a speed of 1 m/min. An oven with a total length of 3 meters was used to perform a two-stage heating process at 110° C. and 130° C. After the solvent was completely evaporated, a rolling process was performed to make the electrode sample in example 1, as shown in FIG. 3.

### Example 2

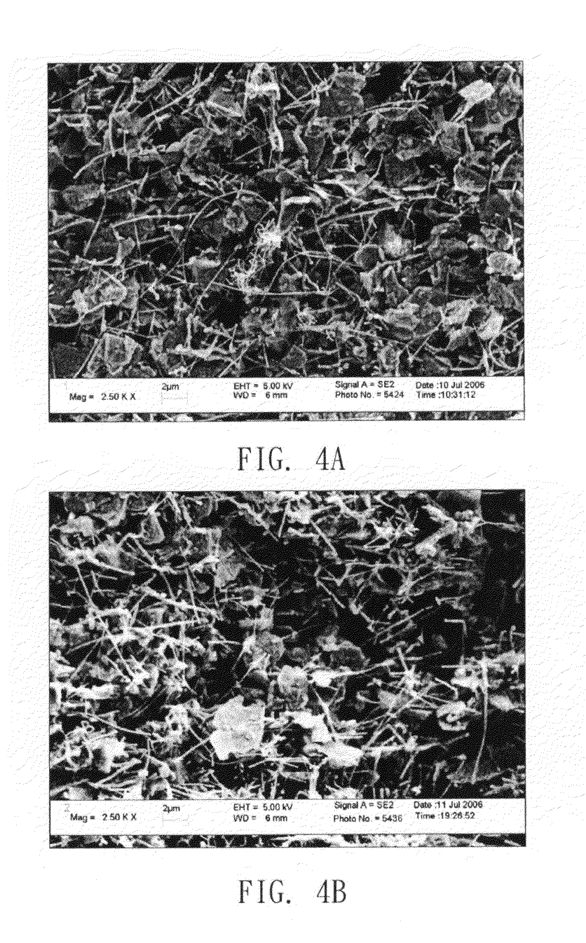

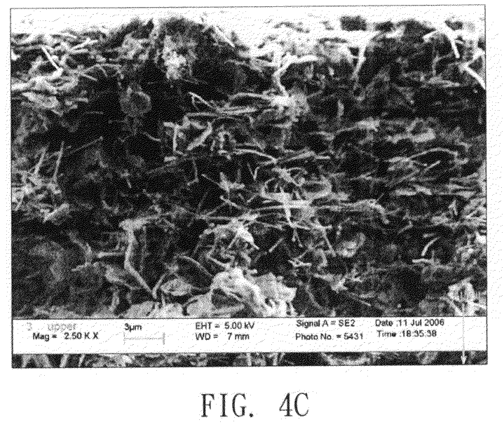

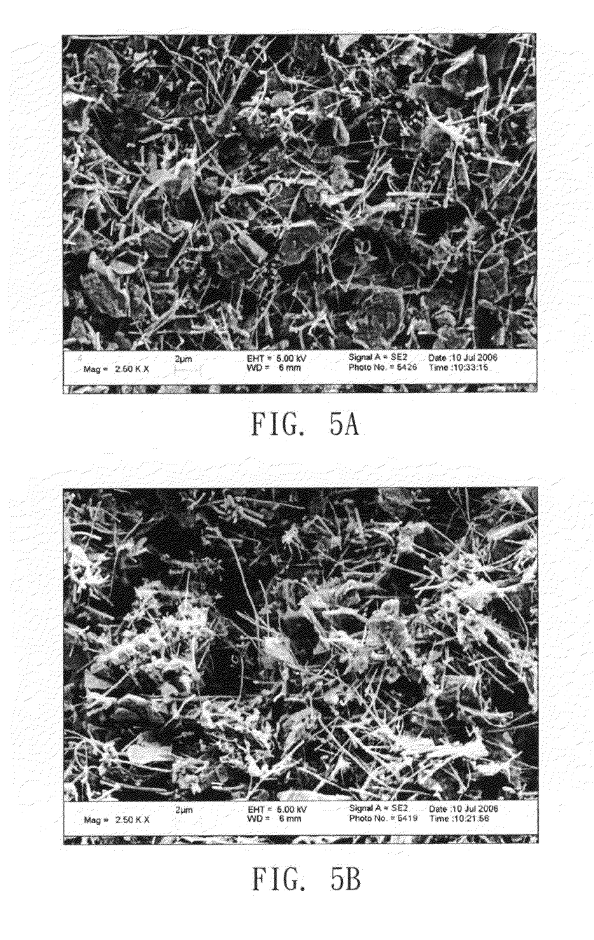

Steps in EXAMPLE 1 were repeated. The amount of lithium cobalt oxide was changed to 91 wt %, the amount of PVDF was changed to 3 wt %, the amount of flaked conductive material KS was changed to 4 wt %, and the amount of tubular conductive material VGCF was changed to 2 wt %. The electrode sample in example 2 was obtained, as shown in FIGS. 4A to 4C.

### Example 3

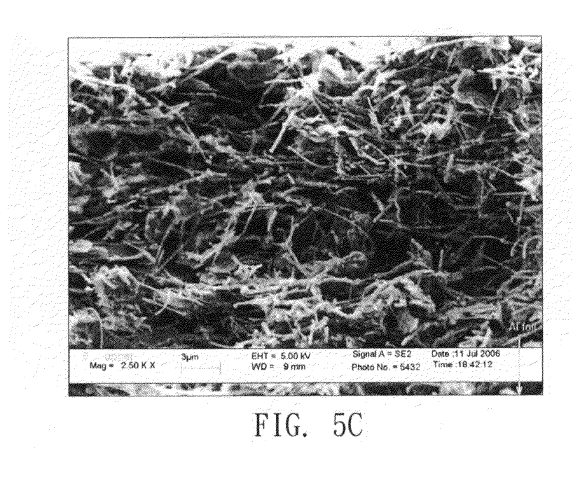

Steps in EXAMPLE 1 were repeated. The amount of lithium cobalt oxide was changed to 91 wt %, the amount of PVDF was changed to 3 wt %, the amount of flaked conductive material KS was changed to 3 wt %, and the amount of tubular conductive material VGCF was changed to 3 wt %. The electrode sample in example 3 was obtained, as shown in FIGS. 5A to 5C.

### Example 4

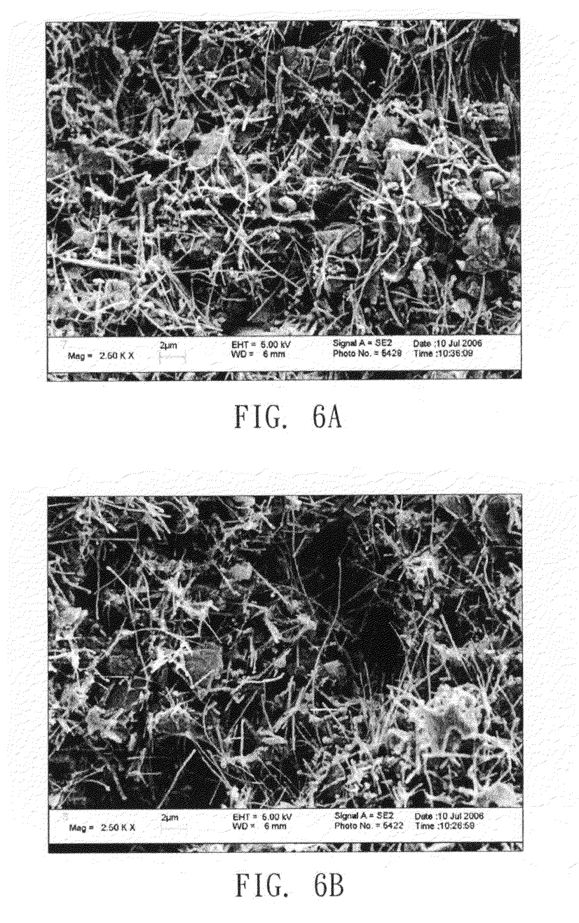

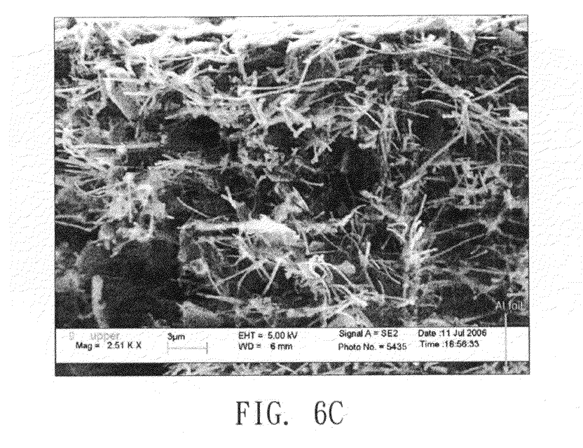

Steps in EXAMPLE 1 were repeated. The amount of lithium cobalt oxide was changed to 91 wt %, the amount of PVDF was changed to 3 wt %, the amount of flaked conductive material KS was changed to 2 wt %, and the amount of tubular conductive material VGCF was changed to 4 wt %. The electrode sample in example 4 was obtained, as shown in FIGS. 6A to 6C.

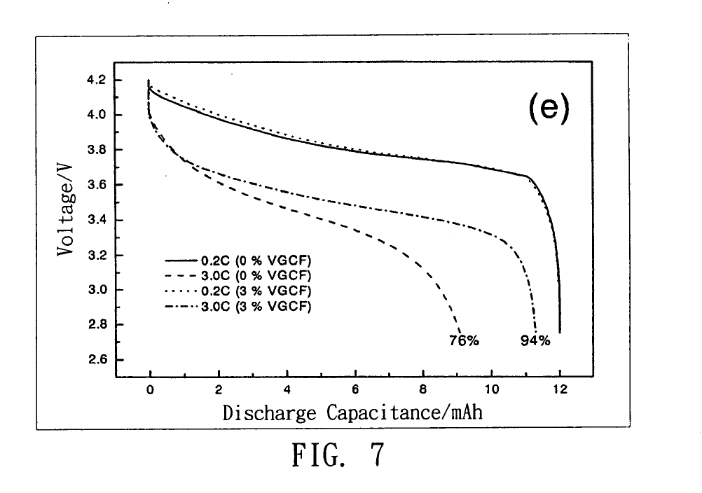

Discharge capacity for high current of a battery is measured, after the battery is assembled with the anode electrode of comparative example 1 or example 1. As shown in FIG. 7, the battery with increased amount of VGCF exhibit greater discharge capacity.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A conductive-structured electrode, comprising:
a tubular 3D electron passage composed of one or more first-type conductive additives for conducting electrons;
a connecting/continuous conductive 3D structure composed of one or more second-type conductive additives for adhering active substances and framing the tubular 3D electron passage structure; and
a 3D porous structure formed by the first-type conductive additives and the second-type conductive additives for providing a conducting passage for one of an electrolyte and an electrolytic ion.

2. The conductive-structured electrode of claim 1, wherein the first-type conductive additive is selected from a group consisting of a tubular conductive material, a striated conductive material, a rod-shaped conductive material, and a fibrous conductive material.

3. The conductive-structured electrode of claim 1, wherein the first-type conductive additives are aggregated into strings for further being combined into a network-like 3D structure.

4. The conductive-structured electrode of claim 1, wherein the first-type conductive additive is a carbon conductive material.

5. The conductive-structured electrode of claim 4, wherein the carbon conductive material is selected from a group consisting of a carbon tube, a carbon fiber, and Vapor Growth Carbon Fiber (VGCF).

6. The conductive-structured electrode of claim 1, wherein the first-type conductive additive is a non-carbon conductive material.

7. The conductive-structured electrode of claim 6, wherein the non-carbon conductive additive is selected from a group consisting of a metal, a conductive composite, and a highly conductive molecule.

8. The conductive-structured electrode of claim 1, wherein the second-type conductive additive is selected from a group consisting of a flaked conductive material, a laminated conductive material, and a granular conductive material.

9. The conductive-structured electrode of claim 1, wherein the second-type conductive additives are stacked into a 3D structure.

10. The conductive-structured electrode of claim 1, wherein the second-type conductive additive is a carbon conductive material.

11. The conductive-structured electrode of claim 10, wherein the carbon conductive material is selected from a group consisting of carbon black, graphite, and carbon-60.

12. The conductive-structured electrode of claim 1, wherein the second-type conductive additive is a non-carbon conductive material.

13. The conductive-structured electrode of claim 12, wherein the non-carbon conductive material is selected from a group consisting of a metal, a conductive composite, and highly conductive molecules.

14. The conductive-structured electrode of claim 1, wherein the 3D porous structure is a porous structure unoccupied by the tubular 3D electron passage structure and the connecting/continuous conductive 3D structure.

15. The conductive-structured electrode of claim 1, wherein the active substance is selected from a group consisting of lithium cobalt oxide (LiCoO₂), lithium manganese oxide (LiMn₂O₄), lithium nickel oxide (LiNiO₂), and lithium iron phosphate (LiFePO₄).

16. The conductive-structured electrode of claim 1, wherein the tubular 3D electron passage structure and the connecting/continuous conductive 3D structure are bounded by an adhesive.

17. The conductive-structured electrode of claim 1, further comprising an electrode substrate.

18. The conductive-structured electrode of claim 17, wherein the electrode substrate is selected from a group consisting of aluminum foil, aluminum alloy foil, nickel foil, platinum foil, and copper alloy foil.

19. The conductive-structured electrode of claim 17, wherein the tubular 3D electron passage structure and the connecting/continuous conductive 3D structure are attached onto the electrode substrate by a high molecular adhesive.

20. The conductive-structured electrode of claim 19, wherein the high molecular adhesive is selected from a group consisting of polyvinylidene fluoride (PVDF), polyarylsulfone (PAS), and polytetrafluoro ethylene (PTEF).
